(19) United States
(12) Patent Application Publication
(10) Pub. No.: US 2015/0297436 A1
(43) Pub. Date: Oct. 22, 2015

(54) Surgical Supporting Device for the Alignment of the Foot, Ankle, Leg, Knee, Thigh and Full Leg

(71) Applicant: VILLARREAL GARZA, MAURICIO, Monterrey, Nuveo Levón (MX)

(72) Inventor: Mauricio Villarreal Garza, Monterrey (MX)

(21) Appl. No.: 14/650,024

(22) PCT Filed: Nov. 8, 2013
(86) PCT No.: PCT/MX2013/000135

§ 371 Date: Jun. 5, 2015

(30) Foreign Application Priority Data
Dec. 6, 2012 (MX) MX/A2012/014311

(51) Int. Cl. A61G 13/12; A61G 13/00

(52) U.S. Cl. CPC A61G 13/125; A61G 13/1245; A61G 13/0036

(57) ABSTRACT

Providing a surgical support instrument for the alignment of the lower extremities comprising modular elements which provides an excellent and not invasive tool that may allow to obtain a 90 degree angle on the foot's sole vs. full leg (upper thigh, knee, leg, ankle and foot) and vice versa, as well as 90 degrees on the foot's sole vs. lower leg (lower leg, ankle and foot) and vice versa. The term patient's lower extremities alignment mainly refers to, but not exclusively, Ankle, Foot and Knee, and such alignment may help the surgeon to achieve a higher success rate on the surgery procedure.

### PURPOSE OF THE INVENTION

Providing a surgical support instrument for the alignment of the lower extremities comprising modular elements which provides an excellent and not invasive tool that may allow to obtain a 90 degree angle on the foot's sole vs. full leg (upper thigh, knee, leg, ankle and foot) and vice versa, as well as 90 degrees on the foot's sole vs. lower leg (lower leg, ankle and foot) and vice versa. The term patient's lower extremities alignment mainly refers to, but not exclusively, Ankle, Foot and Knee, and such alignment may help the surgeon to achieve a higher success rate on the surgery procedure.

### BACKROUND

Currently, alignment methods such as those of a “protractor” type are used, even though the alignment method is ambiguous and leaves margin to error considering that the alignment continues to be visual.

The alignment of the lower extremities of the patient is mainly carried out by the surgeon's assistant using his bare hands, and the final angles necessary to fix some of the bones are measured with devices such as transporters, but the alignment is measured visually and it is very easy to overlook the final angle mainly because the desired final angle of the foot's sole vs. leg is 90 degrees, and an alignment with the tibia bone produces an angle greater than 105 degrees.

Patents US20100263129 and US830302228 owned by Emad Aboujaoude refer to a leg-foot fastening device oriented to align the foot and the leg not allowing any movement. However, the device described in the present disclosure is mainly focused on fastening the leg to the operating table and fastening the foot so that the surgeon can carry out the surgical procedure.

Differing from the above mentioned documents, the present disclosure includes the following:

The section that holds the leg (main piece (1)) has the ability to align the device parallel to the center of gravity and the weight's line of thigh, knee and leg, by having a free space to let the calf muscle outside of the supporting line leg-device.

The section that fastens the foot (secondary piece (2)) comprises a free space at its center which—once that the foot is rightly aligned in the desired angle—, allows the ankle to be drilled with an intramedullary nail through the mentioned space and at the same time allows the surgeon to maneuver or reach the bones of the foot's sole.

### BRIEF DESCRIPTION OF THE FIGURES

FIG. 1 is an upper view of the supporting surgical device where all its parts may be seen.

FIG. 2 is a side view of the supporting surgical device where it can be seen how the main piece (1) and the secondary piece (2) are aligned with the help of the angular piece (3).

FIG. 3 is a perspective view of the surgical supporting device illustrating the main piece (1) and its orifice (4) where the calf muscle may be placed and the secondary piece (2) and its orifice (5), wherein the foot boards, both pieces being aligned forming an angle of 90°.

FIG. 4 is an upper view of the main piece (1) where the orifice (4) that aligns to the height of the leg's calf muscle may be seen.

FIG. 5 is an isometric view of the main piece (1) that illustrates the orifice (4) where the leg's calf muscle is introduced in order to allow the proper alignment of the leg.

FIGS. 6 and 7 are isometric upper views of the secondary piece (2) where the orifice (5) or supporting space can be observed, that is to be aligned with the foot's sole so as to allow surgical boarding.

FIGS. 8 and 9 are isometric lateral views of the angular piece (3) squarely shaped which is used as a referent point to align the reference pieces (1) and (2) in a determined angle.

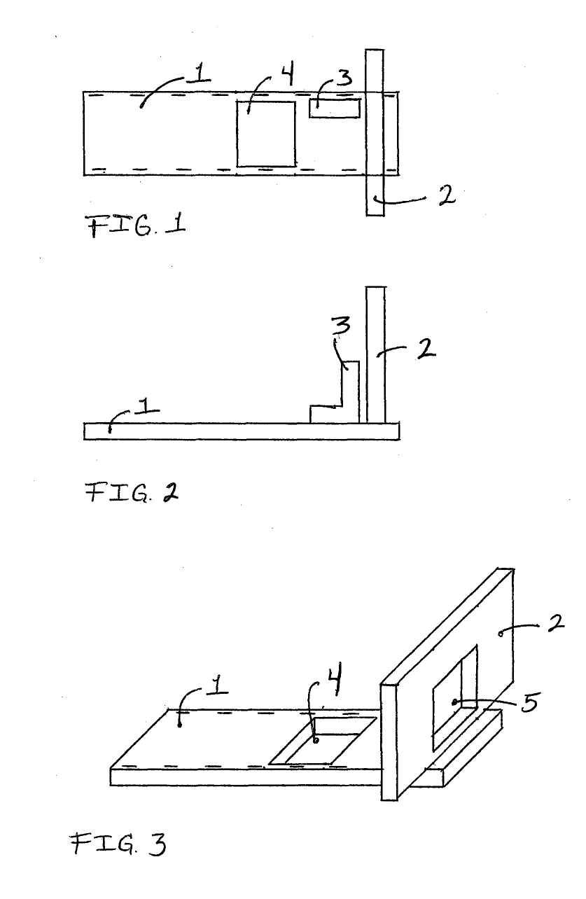

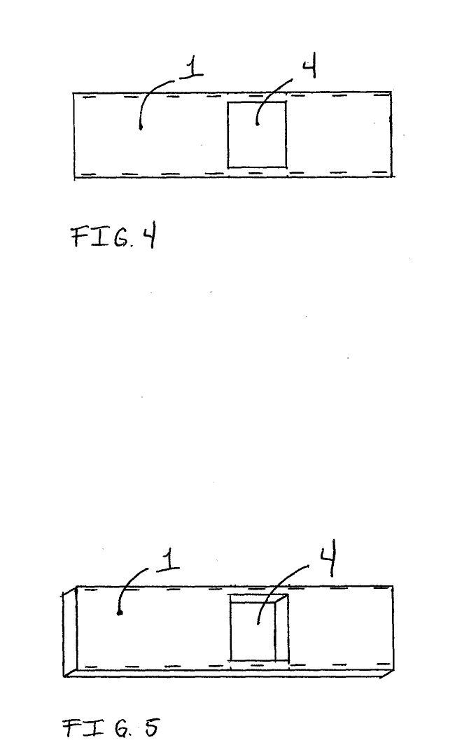

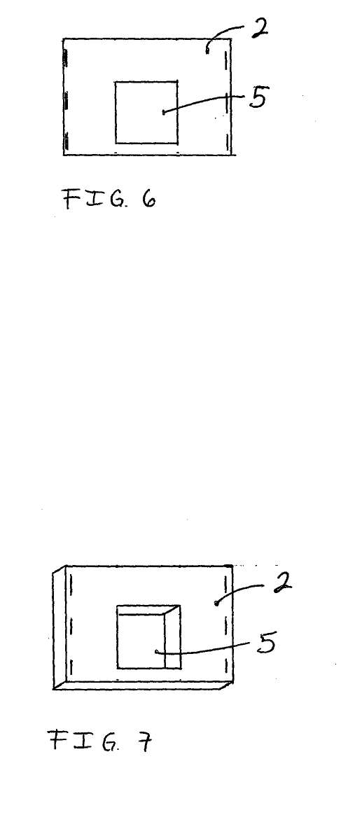

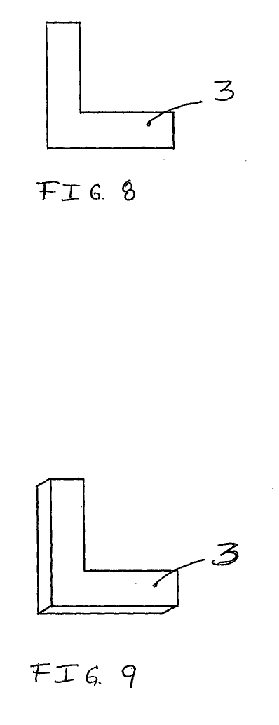

### DETAILED DESCRIPTION OF THE INVENTION

In order to describe the purpose of this invention all human and/or living being will be referred to as patient.

The device comprises 3 parts which may act jointly or separately depending on the surgeon's decision or needs. These pieces can be manufactured in any rigid material that can stand a full leg's weight as well as the foot without being deformed and/or allowing a slight deformation. Such material may be acrylic, plastic, stainless steel, wood or any other material with similar characteristics of the above mentioned materials. Moreover, it must be malleable enough so as to allow perforation or modification, with the aim to obtain a final piece which may have or not have perforations that will allow to use a mechanism to fasten the leg (main piece (1)) or foot (secondary piece (2)), and at the same time will allow to make the necessary perforations to obtain the necessary space for the leg's calf muscle in case of the main piece (1), and perforations for the foot's sole to obtain the necessary space to let the calcaneus free up to the first and fifth metatarsal approximately, for the secondary piece (2). Moreover, if so required, perforations can be included in the lateral extremes of the pieces to implement mechanisms to fasten thigh, knee, leg and foot as it would correspond. The functioning of each one of the device's parts is as follows:

Main piece (1): it is the support of the full leg, is the piece that holds the complete leg including the upper thigh, knee, ankle and foot. It is completely flat on both sides with the purpose of assuring a correct angle of the full leg vs. the foot and/or the foot's sole, where such main piece will have a dimension similar to the length of a patient's leg and which will have an orifice (4) at the extreme closest to the ankle in order to allow the calf muscle to be placed unleveled inside of said orifice. Such main piece comprises a periphery with orifices to introduce the holding forms such as elastic bands or Velcro which help maintain the leg steady.

This main's piece objective is to hold the full leg in such a way that the main piece (1) may be maintained parallel to the weight line or/line of gravity of the full leg or body.

Line of weight or/gravity center: when seeing the human body from a lateral view, it may be observed that the above mentioned line of weight goes from the shoulders, column, pelvis and goes through the back of the upper thigh, comes near the back of the knee and continues directly to the ankle, this line goes through the middle of the calf muscle reaching the ankle and then the heel where the main support of the foot is located.

Orifice (space) (4) for the calf muscle: such piece has an orifice (space) (4) at the calf muscle's height, with the function to allow the calf muscle to go through the piece so that the rest of the leg may be placed on the main piece (1); depending on the patient's physique this orifice may or may not allow the leg to go through it, as long as it lets the calf muscle to go through the piece, which is unleveled with respect to the rest of the leg, and allows the rest of the leg to maintain contact and/or be placed on the surface of the piece with the purpose of maintaining the piece aligned in a parallel form to the line of weight. Analogously, the dimensions of this orifice (space) (4) can be variable depending on the patient's physique, and the orifice can be fixed or retractable as the surgeon deems convenient.

Piece setting: The piece must be placed exactly where the gluteus muscle ends and the leg begins, since the gluteus and the calf muscles are traction muscles that are not parallel to the above mentioned line of weight or center of gravity.

When holding up the thigh, knee, leg and foot this piece will allow the calf muscle go through the orifice (space) (4), and thus resulting in the whole leg being parallel to its line of weight or gravity center, and thus parallel to the contact surface of the piece, thus achieving to offer support to the leg whereas such piece is parallel to the line of weight, in order to be able to use it as a reference when it comes to align the foot for the surgical procedure—if necessary—, this way achieving the desired objective.

Dimensions: dimensions may vary for each patient depending on the length of the full leg and the calf muscle size. Thus, the length, width and thickness of the piece may vary depending on each patient. Therefore, this piece (1) has a retractable modality, using a mechanism to expand and contract the piece to be adjusted to the patient's leg dimensions, and at the same time the orifice (space) (4) must be sufficient so that the calf muscle can be placed out of level with respect to the leg.

Secondary piece (2): the secondary piece is a foot support, and it is the piece that is held against the foot's sole and the one the alignment of the foot with respect to the leg is realised with, thus locating the foot on the surgeon's desired angle. The desired angle is usually 90° between foot's sole vs. full leg.

This secondary piece (2) comprises a preferably flat surface on both sides with the purpose to make the angle formed with this piece with respect to the main piece (1) clearly visible and easy to measure. Moreover, it comprises a central orifice (space) (5) that allows the boarding of the foot's sole bones from the base of the calcaneus up to the metatarsals.

Foot's support plane or contact of the secondary piece (2) contact with the foot: the foot has 3 supporting points that are composed by the calcareous bone and the first and fifth metatarsals. The plane formed by the union of these 3 supporting points is what is called the weight line of the foot, and this support plane is the one which normally requires to be aligned with the leg or full leg.

The section of this second piece (2) that is supported over the calcaneus bone must be of such width that it may allow reaching or boarding for the drilling of the calcaneus bone in its base for those surgeries in which an intramedullary nail in the calcaneus is required.

Orifice (space) (5) central to board: The central space of this secondary piece (2) is sufficient for this piece to make enough pressure and/or to allow it to be placed by touching the holding up plane of the foot that is formed by the three supporting points above mentioned, the orifice dimensions (5) (the space to board) varies for each patient depending on the length of the foot, so that the width, length and thickness of the orifice should/can vary depending on each patient. That is the reason why this piece can be mobile (retractable) depending on the requirements of the operations or as well as on the patient's physique, and so dimensions of the orifice (5) and/or the secondary piece (2) may/should vary.

Placement: the secondary piece (2) is supported on the first part of the foot at the heel's level, precisely the calcaneus bone where the body's weight is held upon. Successively the weight is supported on the next two points that complete the supporting line of the foot (i.e., the first and fifth metatarsals), thus achieving a complete parallel alignment between the secondary piece (2) and the plane drawn by the mobile or fixed (retractable) line depending on the operation's requirements and the patient's complexity that may and/or should change the mentioned dimensions.

Secondary Piece (2):

Dimensions: the piece that is placed over the calcaneus bone must be of a width that it may allow boarding for the drilling of the calcaneus bone on those surgical procedures where an intramedullary nail in the calcaneus bone is required. The dimensions of the rest of the secondary piece (2) may vary for each patient depending on the length of the foot and the distance between the three supporting points of the foot, thus, the length, width and thickness of each piece can and/or may vary depending on each patient, that the reason why this piece (2) can be retractable depending on the surgeon's needs and the patient's physique, which can and/or may vary the mentioned dimensions.

Angular Piece (3): it is an L shaped piece with a 90° angle, with all the plane surfaces in a straight angle. This piece is placed over the main piece (1) so as to form a straight angle, it moves over the main piece (1) until it reaches the secondary piece (2) and in this way it allows to determine the angle difference formed by the main piece (1) vs. the secondary piece (2) vs. the angular piece (3) which is manufactured in 90 degrees.

This piece can be wide enough so as to be placed in the main piece (1) and it will not require being fastened during surgery, or it can be thin so as to be manipulated by the surgeon's assistant.

1. Device for surgical support to the alignment of at least the foot, ankle, leg, knee, thigh and the whole leg, characterized in that it comprises:
a. A first main piece formed by a plate preferably flat on all sides, the plate having a length slightly larger than the leg of the patient undergoing surgery, so that the whole leg may be held up, wherein such first main piece comprises an orifice (space) aligned with the height of the calf muscle of the leg, wherein such orifice has the function of allowing the calf muscle to pass through the piece so that the rest of the leg may be supported in a flat shape and be aligned parallel to the first main piece;
b. a secondary piece formed by a plate preferably flat on all sides, such piece comprises a central orifice that allows boarding the foot's sole bones from the calcaneus to the metatarsal bones;
c. a third L-shaped piece flat on all sides forming preferably an angle of 90 degrees with the purpose of being a support for the alignment of the first and secondary pieces and the lower extremity of the patient's body which requires a surgical procedure.

2. Surgical support device for the alignment of foot, ankle, knee, thigh and whole leg according to claim 1 above, wherein the first main piece is made of a rigid material such as plastic, acrylic, metal or any other element with similar characteristics in order to hold up the weight of the leg, wherein such a piece will have an orifice (space) to allow the introduction of the leg's calf muscle so that the whole leg may be held in a flat way and be maintained aligned parallel to the main piece.

3. Surgical support device for foot, ankle, knee, thigh and whole leg alignment according to claim 2 above, wherein the periphery of the first main piece will have a plurality of orifices to introduce fastening materials such as elastic bands, Velcro or the like which may help keep the leg steady and attached to the first main piece.

4. Surgical supporting device for foot, ankle, knee, thigh and whole leg alignment according to claim 2 above, wherein the first main piece comprises a retractable piece to be adjusted to the leg's dimensions using an extension and contraction mechanism axially aligned to the main body, the piece can be extended taking the desired length by the surgeon.

5. Surgical support device for foot, ankle, knee, thigh and whole leg alignment according to claim 1 above, wherein the secondary piece has the necessary dimensions to provide support to the foot, wherein such piece is placed against the foot's sole in at least three parts: calcaneus bone, first and fifth metatarsal, with which the foot alignment with the leg is carried out up to the desired angle by the surgeon, usually but not exclusively a 90 degree angle in the foot's sole vs. whole leg. It has a central orifice (space) that allows boarding the bones of the foot's sole from the base of the calcaneus up to the metatarsal bone.

6. Surgical support device for foot, ankle, knee, thigh and the whole leg's alignment according to claim 5 above, wherein the secondary piece comprises a space or orifice aligned in such a form that leaves an area that supports the calcaneus bone, wherein such space must be of a sufficient width to allow the boarding/drilling of the calcaneus bone on its base for those surgeries that require intramedullary nail.

7. Surgical support device for foot, ankle, knee, thigh and whole leg alignment according to claim 5 above, wherein the section that is placed over the calcaneus bone must be of such a width enough to allow the boarding/drilling of the calcaneus bone for surgeries that require intramedullary nail going through the calcaneus bone.

8. Surgical support device for foot, ankle, knee, thigh and whole leg alignment according to claim 5 above, wherein the dimensions from the rest of the secondary piece may vary according to each patient's foot length and the distance between the three supporting points of the foot including length, width, thickness of the piece it can and/or should vary depending on each patient, that is why this piece can have a retractable mechanism depending on the surgical procedure's needs as well as the patients physique that can and/or should vary the above mentioned dimensions

9. Surgical support device for foot, ankle, knee, thigh and whole leg alignment according to claim 1 above, wherein the angular piece can be wide enough to be placed in the main piece and does not require to be held during surgery or it can be thin so as to be manipulated by the surgeon's assistant.

10. Surgical support device for foot, ankle, knee, thigh and whole leg alignment according to claim 1 above, wherein the preferable way of use in order to align the first main piece, the secondary piece and the angular piece, is by placing the latter over the main piece in order to form a right angle, the third piece moving over the main piece until it runs into the secondary piece so that the differential of the angle that is formed by the first main piece vs. the secondary piece vs. the 90° angular part, which has been manufactured for that purpose, may be determined.
